(19) United States
(12) Patent Application Publication
(10) Pub. No.: US 2025/0028296 A1
(43) Pub. Date: Jan. 23, 2025

(54) COMPUTATION DEVICE, MACHINING SYSTEM, AND CORRECTION METHOD

(71) Applicant: FANUC CORPORATION, Yamanashi (JP)

(72) Inventors: Yuuta ONOZATO, Yamanashi-ken (JP); Akira YAMAMOTO, Yamanashi-ken (JP)

(21) Appl. No.: 18/549,600

(22) PCT Filed: Mar. 17, 2022
(86) PCT No.: PCT/JP2022/012174

§ 371 Date: Sep. 8, 2023

(30) Foreign Application Priority Data
Mar. 23, 2021 (JP) 2021-048697

(51) Int. Cl. G05B 19/404; B23Q 15/12

(52) U.S. Cl. CPC G05B 19/404; B23Q 15/12; G05B 2219/34149; G05B 2219/39215

(57) ABSTRACT

A computation device according to one embodiment includes a data acquisition unit that acquires shape data pertaining to shapes of a first circular processed groove processed by a rotating member when a tool is present at a first position in a machine coordinate system, and a second circular processed groove processed by the rotating member when the tool is present at a second position; a coordinate calculation unit that calculates, on the basis of the shape data, position coordinates corresponding to the first position based on a rotational center position of the rotating member; and a deviation amount calculation unit that calculates, as a deviation amount, the difference between the first position and the position coordinates.

### TECHNICAL FIELD

The present invention relates to a computation device, a machining system, and a compensation (correction) method.

### BACKGROUND ART

JP H05-200649 A discloses a method for matching the tool center and the rotary table center. In this method, a tool is mounted via an adjustment stand on a rotary table moving in the left-right direction, and a detection sensor is fixed on a feed table moving in the front-rear direction. The detection sensor detects the off-center length of the tool in the left-right direction of the tool when the phase of the rotary table changes by 180°. Thereafter, the position of the tool is compensated in the left-right direction by the adjustment stand by half of the length detected by the detection sensor.

### SUMMARY OF THE INVENTION

However, in JP H05-200649 A, when there is a deviation between the rotation center position (center of rotation) of the rotary table in the machine coordinate system recognized by the numerical controller and the actual rotation center position of the rotary table, the machining accuracy reduces even if the position of the tool is compensated via the adjustment stand.

Therefore, an object of the present invention is to solve the above problem.

The first aspect of the present invention is
a computation device that computes the amount of deviation between a rotation center position of a rotary member and a rotation center position in a machine coordinate system of a machine tool wherein the machine tool includes the rotary member on which a workpiece is placed and a movable member to which a tool machining the workpiece is attached and that is provided so as to be movable with respect to the rotary member,
the computation device including a data acquisition unit configured to acquire shape data regarding shapes of a first circular machining groove formed by the rotation of the rotary member when the tool is at a first position in the machine coordinate system and of a second circular machining groove formed by the rotation of the rotary member when the tool is at a second position different from the first position,
a coordinate calculation unit configured to calculate the position coordinates corresponding to the first position with respect to the rotation center position of the rotary member based on the shape data, and
a deviation amount calculation unit configured to calculate a difference between the first position and the position coordinates as the amount of deviation.

The second aspect of the present invention is a machining system including
a computation device according to the first aspect, the machine tool, a control unit configured to control the machine tool, and a measurement device configured to measure the first circular machining groove and the second circular machining groove.

The third aspect of the present invention is a compensation method of compensating a rotation center position in the machine coordinate system of a machine tool that includes a rotary member that rotates a workpiece and a movable member to which a tool machining the workpiece is attached and that is provided so as to be movable with respect to the rotary member, including:
a data acquisition step of acquiring shape data regarding shapes of a first circular machining groove formed by rotation of the rotary member when the tool is at a first position in the machine coordinate system and a second circular machining groove formed by rotation of the rotary member when the tool is at a second position different from the first position;
a coordinate calculation step of calculating the position coordinates corresponding to the first position with respect to the rotation center position of the rotary member based on the shape data;
a deviation amount calculation step of calculating the difference between the first position and the position coordinates as the amount of deviation between the rotation center position in the machine coordinate system and the rotation center position of the rotary member;
a compensation step of compensating the rotation center position in the machine coordinate system based on the amount of deviation.

According to the aspect of the present invention, it is possible to grasp whether there is a gap between the rotation center position in the machine coordinate system and the actual rotation center position, and as a result, machining accuracy can be improved.

### BRIEF DESCRIPTION OF DRAWINGS

FIG. 1 is a block diagram illustrating a machining system of an embodiment;

FIG. 2 is a flow chart showing the procedure of a compensation method of compensating a rotation center position (center of rotation) in a machine coordinate system of a machine tool;

FIG. 3 shows grooves of a workpiece made when the workpiece is machined in a pre-processing step;

FIG. 4 is a diagram showing how a measurement is taken;

FIG. 5 is a diagram showing a waveform measured by a measurement device; and

FIG. 6 is a conceptual diagram showing how the calculation is performed in a calculation step.

### DETAILED DESCRIPTION OF THE INVENTION

### Embodiment

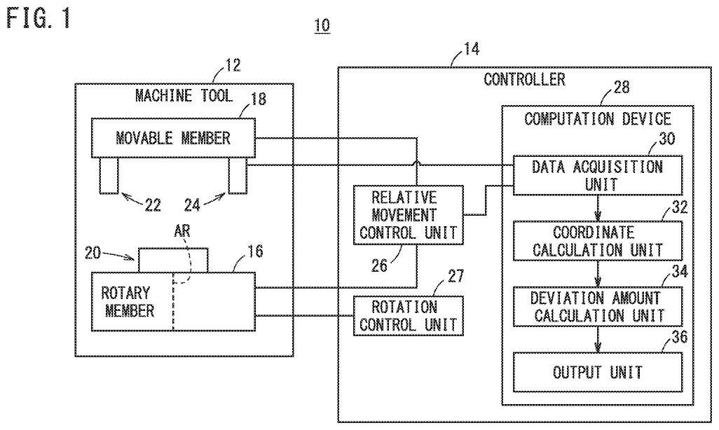

FIG. 1 is a block diagram illustrating a machining system 10 of an embodiment. The machining system 10 is provided with a machine tool 12 and a controller 14 for controlling the machine tool 12. The controller 14 defines a machine coordinate system of the machine tool 12. This machine coordinate system is a Cartesian coordinate system on software. The machine coordinate system is stored in a memory possessed by the controller 14. The controller 14 controls the machine tool 12 according to the machine coordinate system stored in the memory.

In the present embodiment, the direction corresponding to the X-axis (or Y-axis) of the machine coordinate system is taken as the first direction. Also, the direction corresponding to the Y-axis (or X-axis) of the machine coordinate system is taken as the second direction. Also, the direction corresponding to the Z-axis of the machine coordinate system is taken as the third direction. The first direction and the second direction are orthogonal in a plane, and the third direction is orthogonal to each of the first direction and the second direction.

The machine tool 12 has a rotary member 16 and a movable member 18. The rotary member 16 is rotatable around a rotary axis AR. The movable member 18 is movable in each of the X, Y and Z directions.

A workpiece 20 is placed on the surface of the rotary member 16 close to the movable member 18. The workpiece 20 may be a real piece for a real product or a test piece for a test.

A tool 22 and a measurement device 24 are attached to the movable member 18. The tool 22 is an instrument for machining the workpiece 20. The measurement device 24 can measure a machining surface of the workpiece 20 machined by the tool 22. As examples of the measurement device 24, a probe for measuring a distance to the workpiece 20, a camera for imaging the machining surface of the workpiece 20, and suchlike can be raised. In this embodiment, the measurement device 24 is a probe that measures the distance to the workpiece 20.

The controller 14 has a relative movement control unit 26 and a rotation control unit 27. The relative movement control unit 26 relatively moves the movable member 18 with respect to the rotary member 16 based on the machine coordinate system. The rotation control unit 27 rotates the rotary member 16. The controller 14 is equipped with a computation device 28. The computation device 28 computes the amount of deviation between an actual rotation center position of the rotary member 16 and a rotation center position (center of rotation) of the rotary member 16 in the machine coordinate system. The controller 14 compensates the rotation center position of the rotary member 16 in the machine coordinate system based on the amount of deviation computed by the computation device 28.

The computation device 28 has a processor(s) and a memory(s) in which a computation program(s) is stored. When the processor executes the computation program, the computation device 28 performs processes specified by the computation program to realize a data acquisition unit 30, a coordinate calculation unit 32, a deviation amount calculation unit 34, and an output unit 36. The data acquisition unit 30, the coordinate calculation unit 32, the deviation amount calculation unit 34, and the output unit 36 will be described later. The computation device 28 may be mounted on an external device such as a personal computer. When the computation device 28 is mounted on an external device, the external device is connected to the controller 14 by wire or wirelessly in such a way that various types of information can be exchanged with the controller 14.

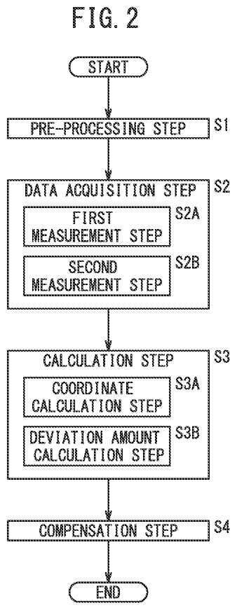

FIG. 2 is a flow chart showing the procedure of a compensation method of compensating the rotation center position in a machine coordinate system of the machine tool 12. The compensation method includes a pre-processing step S1, a data acquisition step S2, a calculation step S3, and a compensation step S4. Each of the pre-processing step S1, the data acquisition step S2, the calculation step S3, and the compensation step S4 is described in detail below.

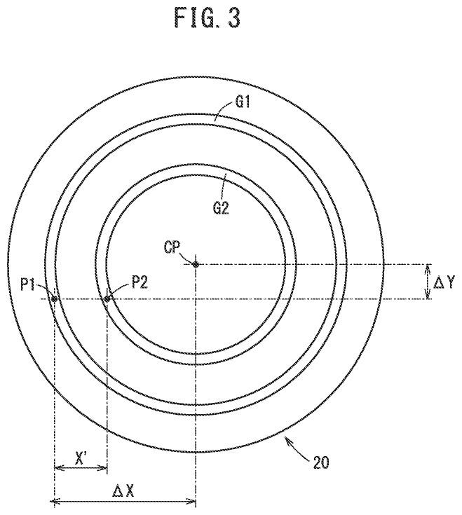

FIG. 3 shows grooves of the workpiece 20 made when the workpiece 20 is machined in the pre-processing step S1. The pre-processing step S1 is a step of forming, on the machining surface of the workpiece 20, a first circular machining groove G1 and a second circular machining groove G2 that have different diameters and the same center.

The first circular machining groove G1 is formed under the control of the relative movement control unit 26 and the rotation control unit 27. That is, the relative movement control unit 26 controls the movable member 18 so that the tool 22 moves to a first position P1. After that, while the tool 22 is positioned at the first position P1, the rotation control unit 27 rotates the rotary member 16 so as to rotate at a predetermined rotational speed. In this way, the first circular machining groove G1 is formed.

The second circular machining groove G2 is formed under the control of the relative movement control unit 26 and the rotation control unit 27, similarly to the first circular machining groove G1. That is, the relative movement control unit 26 controls the movable member 18 so that the tool 22 moves to a second position P2. After that, with the tool 22 is positioned at the second position P2, the rotation control unit 27 rotates the rotary member 16 so as to rotate at a predetermined rotational speed. Thus, the second circular machining groove G2 is formed.

The second position P2 is a position separated from the first position P1 by a distance X′ in a first direction (a direction corresponding to the X-axis or the Y-axis). The centers of the first circular machining groove G1 and the second circular machining groove G2 coincide with an actual rotation center position CP of the rotary member 16. The first position P1 and the distance X′ between the first position P1 and the second position P2 are set in advance in the computation program. The settings of the first position P1 and the distance X′ between the first position P1 and the second position P2 may be changed according to a user's operation on an operating unit of the machining system 10.

The data acquisition step S2 is a step of acquiring shape data regarding the shapes of the first circular machining groove G1 and the second circular machining groove G2. In the data acquisition step S2, the data acquisition unit 30 (FIG. 1) of the computation device 28 acquires, as shape data, position coordinates (Mx, My) of the first position P1 in the machine coordinate system and the distance X′ between the first position P1 and the second position P2. The data acquisition unit 30 may acquire the position coordinates (Mx, My) and the distance X′ from the relative movement control unit 26, or may acquire the position coordinates (Mx, My) and the distance X′ by analyzing the computation program.

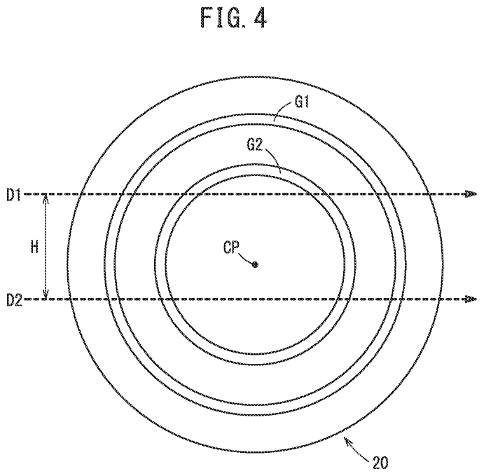

FIG. 4 is a diagram showing how a measurement is taken. The data acquisition step S2 includes a first measurement step S2A (FIG. 2). The first measurement step S2A is a step of measuring the shapes of the first circular machining groove G1 and the second circular machining groove G2 along a first measurement path D1. The data acquisition step S2 also includes a second measurement step S2B (FIG. 2). The second measurement step S2B is a step of measuring the shapes of the first circular machining groove G1 and the second circular machining groove G2 along a second measurement path D2.

The first measurement path D1 and the second measurement path D2 are in a parallel relation, and an interval H between the first measurement path D1 and the second measurement path D2 is set in advance in the computation program. The setting of the interval H between the first measurement path D1 and the second measurement path D2 may be changed according to the user's operation on the operating unit of the machining system 10.

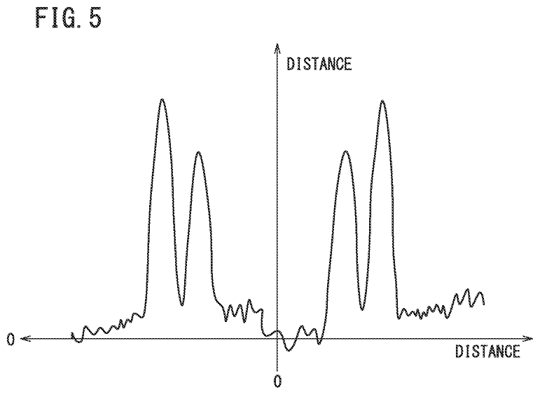

In the first measurement step S2A, the relative movement control unit 26 controls the movable member 18 so that the measurement device 24 passes across the first circular machining groove G1 and the second circular machining groove G2 in the first direction. Thereby, the measurement device 24 moves along the first measurement path D1. During this movement, the measurement device 24 measures the first measurement path D1. Measurement values of the measurement device 24 are obtained as a waveform in which the distance to the workpiece 20 peaks at the positions of the first circular machining groove G1 and the second circular machining groove G2 intersecting the first measurement path D1 (see FIG. 5).

In the second measurement step S2B, the relative movement control unit 26 controls the movable member 18 along the first direction so that the measurement device 24 displaced in the second direction orthogonal to the first direction passes across the first circular machining groove G1 and the second circular machining groove G2. This causes the measurement device 24 to move along the second measurement path D2. During this movement, the measurement device 24 measures the second measurement path D2. Measurement values of the measurement device 24 are obtained as a waveform in which the distance to the workpiece 20 peaks at the positions of the first circular machining groove G1 and the second circular machining groove G2 intersecting the second measurement path D2, though not exemplified here.

In the data acquisition step S2, the data acquisition unit 30 of the computation device 28 further acquires shape data. That is, the data acquisition unit 30 acquires, as shape data, the interval H between the first measurement path D1 and the second measurement path D2 and the measurement values of the measurement device 24 measured in the first measurement step S2A and the second measurement step S2B. The data acquisition unit 30 may acquire the interval H between the first measurement path D1 and the second measurement path D2 from the relative movement control unit 26, or may acquire the interval H between the first measurement path D1 and the second measurement path D2 by analyzing the computation program.

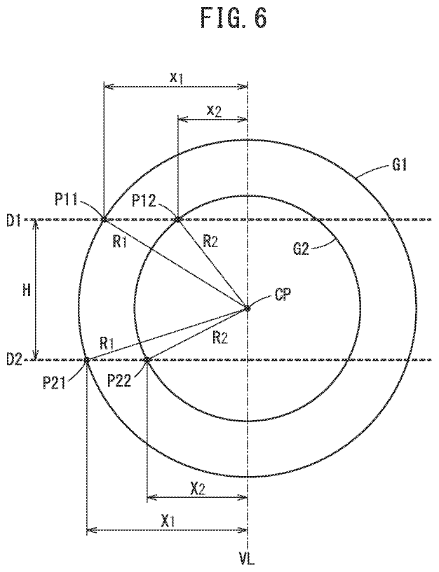

FIG. 6 is a conceptual diagram showing how the calculation is performed in the calculation step S3. The calculation step S3 is a step of calculating the amount of deviation between the rotation center position CP of the rotary member 16 and the rotation center position in the machine coordinate system, based on the shape data acquired in the data acquisition step S2. The calculation step S3 includes a coordinate calculation step S3A and a deviation amount calculation step S3B.

In the coordinate calculation step S3A, the coordinate calculation unit 32 (FIG. 2) of the computation device 28 calculates position coordinates (ΔX, ΔY) corresponding to the first position P1 with reference to the actual rotation center position CP (FIG. 3) of the rotary member 16 based on the shape data.

Here, a calculation method of the coordinate calculation unit 32 is taken as an example. That is, the coordinate calculation unit 32 calculates the radius R₁ of the first circular machining groove G1 through Equation (1). In addition, the coordinate calculation unit 32 calculates the radius R₂ of the second circular machining groove G2 through Equation (2). The calculations use the measurement value of the measurement device 24 and the interval H between the first measurement path D1 and the second measurement path D2.

$${R}_{1} = \sqrt{{X}_{1}^{2} + {( \frac{{H}^{2} - {x}_{1}^{2} - {X}_{1}^{2}}{2 H} )}^{2}} \qquad ( 1 )$$

$${R}_{2} = \sqrt{{X}_{2}^{2} + {( \frac{{H}^{2} - {x}_{2}^{2} - {X}_{2}^{2}}{2 H} )}^{2}} \qquad ( 2 )$$

x₁ in Equation (1) is the distance from an intersection point P11 of the first measurement path D1 and the first circular machining groove G1 to a virtual line VL passing through the rotation center position CP of the rotary member 16 and being orthogonal to the first measurement path D1 (FIG. 6). X₁ in Equation (1) is the distance from the intersection point P21 of the second measurement path D2 and the first circular machining groove G1 to the virtual line VL (FIG. 6). x₂ in Equation (2) is the distance from the intersection point P12 of the first measurement path D1 and the second circular machining groove G2 to the virtual line VL, and X₂ in Equation (2) is the distance from the intersection P22 of the second measurement path D2 and the second circular machining groove G2 to the virtual line VL (FIG. 6).

In addition, the coordinate calculation unit 32 calculates the position coordinates (ΔX, ΔY) corresponding to the first position P1 with reference to the rotation center position CP according to Equation (3). The calculations use the radius R₁ of the first circular machining groove G1 and the radius R₂ of the second circular machining groove G2, and the distance X′ between the first position P1 and the second position P2 (FIG. 3).

$$Δ X = \sqrt{{R}_{1}^{2} - {( \frac{2 S}{{X}^{′}} )}^{2}} Δ Y = \frac{2 S}{{X}^{′}} \qquad ( 3 )$$

S in Equation (3) is a value obtained from Heron's formula shown in Equation (4).

$$S = \sqrt{s ( s - {R}_{1} ) ( s - {R}_{2} ) ( s - {X}^{′} )} ( S = \frac{{R}_{1} + {R}_{2} + {X}^{′}}{2} ) \qquad ( 4 )$$

In the deviation amount calculation step S3B, the deviation amount calculation unit 34 (FIG. 1) of the computation device 28 calculates, as the amount of deviation, the difference between the position coordinates (ΔX, ΔY) and the position coordinates (Mx, My) of the machine coordinate system of the first position P1. The position coordinates (ΔX, ΔY) are calculated by the coordinate calculation unit 32 in the coordinate calculation step S3A.

Here, when there is a difference (the difference greater than 0) in X component (|Mx−ΔX|) or Y component (|My−ΔY|) between the position coordinates and the position coordinates of the machine coordinate system, a deviation occurs between the actual rotation center position CP of the rotary member 16 and the rotation center position of the rotary member 16 in the machine coordinate system.

The output unit 36 (FIG. 1) of the computation device 28 outputs the calculated amount of deviation to the outside. When there is a difference (deviation) in at least one of the X component and the Y component between the calculated position coordinates and the position coordinates of the machine coordinate system, the output unit 36 may output to the outside, together with the amount of deviation, information that the rotation center position of the machine coordinate system is in a state of deviation.

The compensation step S4 is a step of compensating the rotation center position of the rotary member 16 in the machine coordinate system based on the amount of deviation calculated in the calculation step S3. In the compensation step S4, the controller 14 compares the amount of deviation calculated by the deviation amount calculation unit 34 of the computation device 28 with a threshold value. If the amount of deviation exceeds the threshold value, the controller 14 compensates the rotation center position in the machine coordinate system so that the amount of deviation is smaller than the threshold value.

As described above, in the present embodiment, the position coordinates (ΔX, ΔY) corresponding to the first position P1 with respect to the rotation center position CP are calculated based on the shape data regarding the shapes of the first circular machining groove G1 and the second circular machining groove G2. In addition, in this embodiment, the difference between the position coordinates (ΔX, ΔY) and the first position P1 (position coordinates (Mx, My) in the machine coordinate system) is calculated as the amount of deviation between the actual rotation center position CP of the rotary member 16 and the rotation center position of the rotary member 16 in the machine coordinate system.

Thus, it is possible to grasp whether there is a deviation between the actual rotation center position CP and the rotation center position in the machine coordinate system, and if there is a deviation, it is possible to give an opportunity to compensate the rotation center position in the machine coordinate system. As a result, the machining accuracy can be improved.

In the present embodiment, a computation device 28 is mounted on the controller 14 that controls the machine tool 12.

Thus, even if the computation device 28 is not connected to the controller 14, it is possible to grasp whether there is a deviation between the actual rotation center position CP and the rotation center position in the machine coordinate system.

In this embodiment, the rotation center position in the machine coordinate system is compensated based on the amount of deviation.

This makes it possible to compensate the rotation center position in the machine coordinate system when there is a deviation, resulting in improved machining accuracy.

In this embodiment, the first circular machining groove G1 is formed by rotating the rotary member 16 after controlling the movable member 18 so that the tool 22 moves to the first position P1. Further, the second circular machining groove G2 is formed by rotating the rotary member 16 after controlling the movable member 18 so that the tool 22 moves to the second position P2.

Thus, shape data concerning the shapes of the first circular machining groove G1 and the second circular machining groove G2 can be acquired even if another machining device different from the machining system 10 does not form the first circular machining groove G1 and the second circular machining groove G2 in advance.

In this embodiment, the shape of the first circular machining groove G1 is measured by controlling the movable member 18 so that the measurement device 24 attached to the movable member 18 passes across the first circular machining groove G1 along the first direction. Similarly, the shape of the second circular machining groove G2 is measured by controlling the movable member 18 so that the measurement device 24 passes across the second circular machining groove G2 along the first direction. Moreover, the shape of the first circular machining groove G1 is measured by controlling the movable member 18 so that the measurement device 24 displaced in the second direction orthogonal to the first direction passes across the first circular machining groove G1 along the second direction. Similarly, the shape of the second circular machining groove G2 is measured by controlling the movable member 18 so that the measurement device 24 displaced in the second direction passes across the second circular machining groove G2 along the second direction.

Thus, the measurement values of the shapes of the first circular machining groove G1 and the second circular machining groove G2 can be acquired as shape data without any other measurement devices different from the machine tool 12 and the measurement device 24.

### Modified Example

The above-described embodiment may be modified as follows.

The first circular machining groove G1 and the second circular machining groove G2 may be formed on the machining surface of the workpiece 20 with other machining devices different from the machining system 10. In this case, the first position P1 (FIG. 3) and the distance X′ (FIG. 3) between the first position P1 and the second position P2 (FIG. 3) are input, for example, according to the user's operation on the operating unit of the machining system 10. The data acquisition unit 30 of the computation device 28 also acquires the input position coordinates (Mx, My) and the distance X′ as shape data.

Moreover, the shapes of the first circular machining groove G1 and the second circular machining groove G2 may be measured by other measurement machines different from the machine tool 12 and the measurement device 24. In this case, the data acquisition unit 30 of the computation device 28 acquires, as shape data, the distance H (FIG. 4) between the first measurement path D1 and the second measurement path D2 and the measurement values of the shapes of the first circular machining groove G1 and the second circular machining groove G2 from other measurement machines. The data acquisition unit 30 may acquire, as shape data, the intervals H (FIG. 4) and the measurement values that are input according to the user's operation on the operating unit of the machining system 10.

### Inventions

The following describes the invention that can be understood from the above-mentioned embodiments and modified examples.

### First Invention

The first invention is the computation device (28) that computes the amount of deviation between the rotation center position of the rotary member and the rotation center position in the machine coordinate system of the machine tool (12) wherein the machine tool includes the rotary member (16) on which the workpiece (20) is placed, and the movable member (18) to which the tool (22) machining the workpiece is attached and that is provided so as to be relatively movable with respect to the rotary member,
the computation device includes the data acquisition unit (30) configured to acquire shape data regarding a shape of the first circular machining groove (G1) formed by the rotation of the rotary member when the tool is at the first position (P1) in the machine coordinate system and regarding a shape of the second circular machining groove (G2) formed by the rotation of the rotary member when the tool is at the second position (P2) different from the first position, the coordinate calculation unit (32) that calculates the position coordinate (ΔX, ΔY) corresponding to the first position with respect to the rotation center position (CP) of the rotary member based on the shape data, and the deviation amount calculation unit (34) configured to calculate the difference between the first position and the position coordinates as the amount of deviation.

Thus, it is possible to grasp whether there is a deviation between the actual rotation center position and the rotation center position in the machine coordinate system, and if there is the deviation, it is possible to give an opportunity to compensate the rotation center position in the machine coordinate system. As a result, the machining accuracy can be improved.

The computation device may be mounted in the controller (14) configured to control the machine tool. Thus, even if the computation device is not connected to the control unit, it is possible to grasp whether there is a deviation between the actual rotation center position CP and the rotation center position in the machine coordinate system.

### Second Invention

The second invention is the machining system (10) including the computation device, the machine tool, the controller configured to control the machine tool, and the measurement device (24) configured to measures the first circular machining groove and the second circular machining groove.

Since the above-mentioned computation device is provided, it is possible to grasp whether there is a deviation between the rotation center position in the machine coordinate system and the actual rotation center position, and if there is the deviation, it is possible to give an opportunity to compensate the rotation center position in the machine coordinate system. As a result, the machining accuracy can be improved.

The controller may compensate the rotation center position in the machine coordinate system based on the amount of deviation. This makes it possible to compensate the rotation center position in the machine coordinate system, resulting in improved machining accuracy.

### Third Invention

The third invention is the compensation method of compensating the rotation center position in the machine coordinate system of the machine tool that includes the rotary member that rotates the workpiece, and the movable member to which the tool machining the workpiece is attached and that is provided so as to be movable with respect to the rotary member.

The compensation method includes: the data acquisition step (S2) of acquiring shape data regarding the shape of the first circular machining groove formed by the rotation of the rotary member when the tool is at the first position in the machine coordinate system and regarding the shape of the second circular machining groove formed by the rotation of the rotary member when the tool is at the second position different from the first position; the coordinate calculation step (S3A) of calculating position coordinates corresponding to the first position with respect to the rotation center position of the rotary member based on the shape data; the deviation amount calculation step (S3B) of calculating the difference between the first position and the position coordinates as the amount of deviation between the rotation center position in the machine coordinate system and the rotation center position of the rotary member; and the compensation step (S4) of compensating the rotation center position in the machine coordinate system based on the amount of deviation.

Thus, when there is a gap between the rotation center position in the machine coordinate system and the actual rotation center position, the rotation center position in the machine coordinate system can be compensated, and as a result, the machining accuracy can be improved.

The compensation method may include the pre-processing step (S1) of forming the first circular machining groove by rotating the rotary member after controlling the movable member in a manner so that the tool moves to the first position, and forming the second circular machining groove by rotating the rotary member after controlling the movable member in a manner so that the tool moves to the second position.

This makes it possible to acquire shape data about the shapes of the first circular machining groove and the second circular machining groove by another machining device different from the machining system, without forming the first circular machining groove and the second circular machining groove in advance.

The data acquisition step may include the first measurement step (S2A) of measuring the shapes by controlling the movable member in a manner so that the measurement device attached to the movable member passes across the first circular machining groove and the second circular machining groove along the first direction, and the second measurement step (S2B) of measuring the shapes by controlling the movable member in a manner so that the measurement device displaced in a second direction orthogonal to the first direction passes across the first circular machining groove and the second circular machining groove along the first direction, and in the coordinate calculation step, the measurement values measured in the first measurement step and the second measurement step may be used as the shape data.

Thus, even if the shapes of the first circular machining groove and the second circular machining groove are not measured using another measurement machine different from the machine tool and the measurement device, the measurement values of the shapes of the first circular machining groove and the second circular machining groove can be acquired as shape data.

1. A computation device that computes an amount of deviation between a rotation center position of a rotary member and a rotation center position in a machine coordinate system of a machine tool that includes: the rotary member on which a workpiece is placed; and a movable member to which a tool machining the workpiece is attached and that is provided so as to be movable with respect to the rotary member,
the computation device comprising:
a data acquisition unit configured to acquire shape data regarding a shape of a first circular machining groove formed by rotation of the rotary member when the tool is at a first position in the machine coordinate system and regarding a shape of a second circular machining groove formed by the rotation of the rotary member when the tool is at a second position different from the first position;
a coordinate calculation unit configured to calculate a position coordinate corresponding to the first position with respect to the rotation center position of the rotary member based on the shape data; and
a deviation amount calculation unit configured to calculate a difference between the first position and the position coordinate as the amount of deviation.

2. The computation device according to claim 1, wherein
the computation device is mounted in a controller configured to control the machine tool.

3. A machining system comprising:
the computation device according to claim 1;
the machine tool;
a controller configured to control the machine tool; and
a measurement device configured to measure the first circular machining groove and the second circular machining groove.

4. The machining system according to claim 3, wherein
the controller compensates the rotation center position in the machine coordinate system based on the amount of deviation.

5. A compensation method of compensating a rotation center position in a machine coordinate system of a machine tool that includes a rotary member that rotates a workpiece, and a movable member to which a tool machining the workpiece is attached and that is provided so as to be movable with respect to the rotary member,
the compensation method comprising:
a data acquisition step of acquiring shape data regarding a shape of a first circular machining groove formed by rotation of the rotary member when the tool is at a first position in the machine coordinate system and regarding a shape of a second circular machining groove formed by the rotation of the rotary member when the tool is at a second position different from the first position;
a coordinate calculation step of calculating a position coordinate corresponding to the first position with respect to a rotation center position of the rotary member based on the shape data;
a deviation amount calculation step of calculating a difference between the first position and the position coordinate as an amount of deviation between the rotation center position in the machine coordinate system and the rotation center position of the rotary member; and
a compensation step of compensating the rotation center position in the machine coordinate system based on the amount of deviation.

6. The compensation method according to claim 5, further comprising
a pre-processing step of forming the first circular machining groove by rotating the rotary member after controlling the movable member in a manner so that the tool moves to the first position, and forming the second circular machining groove by rotating the rotary member after controlling the movable member in a manner so that the tool moves to the second position.

7. The compensation method according to claim 5, wherein
the data acquisition step comprises:
a first measurement step of measuring the shapes by controlling the movable member in a manner so that a measurement device attached to the movable member passes across the first circular machining groove and the second circular machining groove along a first direction; and
a second measurement step of measuring the shapes by controlling the movable member in a manner so that the measurement device displaced in a second direction orthogonal to the first direction passes across the first circular machining groove and the second circular machining groove along the first direction, and
in the coordinate calculation step, measurement values measured in the first measurement step and the second measurement step are used as the shape data.
